(19) United States
(12) Patent Application Publication
(10) Pub. No.: US 2017/0154293 A1
(43) Pub. Date: Jun. 1, 2017

(54) CUSTOMER SERVICE APPRAISAL DEVICE, CUSTOMER SERVICE APPRAISAL SYSTEM, AND CUSTOMER SERVICE APPRAISAL METHOD

(71) Applicant: PANASONIC INTELLECTUAL PROPERTY MANAGEMENT CO., LTD., Osaka (JP)

(72) Inventors: Thilmee BADUGE, Tokyo (JP); Shinichi SHIGENAGA, Tokyo (JP); Ryota FUJII, Fukuoka (JP)

(73) Assignee: PANASONIC INTELLECTUAL PROPERTY MANAGEMENT CO., LTD., Osaka (JP)

(21) Appl. No.: 15/316,223

(22) PCT Filed: Jun. 4, 2015
(86) PCT No.: PCT/JP2015/002827

§ 371 Date: Dec. 5, 2016

(30) Foreign Application Priority Data
Jun. 16, 2014 (JP) 2014-123640
Jan. 28, 2015 (JP) 2015-013939

(51) Int. Cl. G06Q 10/06; G10L 25/87; G10L 25/63; G10L 15/10; G10L 15/02

(52) U.S. Cl. CPC G06Q 10/06398; G10L 15/10; G10L 15/02; G10L 25/63; G10L 25/87; G06Q 30/0613

(57) ABSTRACT

A customer service appraisal device which appraises a customer service attitude of a person includes a voice input terminal in which voice of the person is input as a voice signal, a keyword detector which detects one or more predetermined customer service keywords from the voice of the person by acquiring the voice signal, a voice feature acquirer which acquires a voice feature value of the customer service keyword that is detected by the keyword detector, and a customer service score calculator which calculates an appraisal value that is an indicator of good or bad of the customer service attitude of the person based on a detection amount and the voice feature value of the customer service keyword by the keyword detector.

### TECHNICAL FIELD

The present invention relates to a customer service appraisal device which appraises a customer service attitude of a person, a customer service appraisal system, and a customer service appraisal method.

### BACKGROUND ART

In service industries such as retail and hotels, it is known that a favorable customer service attitude of employees or the like leads to customer satisfaction, and as a result, a customer attraction rate and sales improve. As a method for appraising the customer service attitude of employees or the like, a customer opinion survey or the like is generally carried out, but since such a customer service appraisal method is carried out by input of multiple staff members, there is a problem and inefficiency or objectivity being poor.

Therefore, in the related art, there is provided a customer service data recording apparatus which records customer service data to ascertain a relationship of a conversation ratio of a customer with a shop assistant who is actually serving the customer and customer satisfaction and estimates the degree of customer satisfaction affected by the conversion ratio, thereby, being able to demonstrate results of conversation training (refer to PTL 1).

### CITATION LIST

### Patent Literature

PTL 1: Japanese Patent No. 5477153

### SUMMARY OF THE INVENTION

In the related art which is described in PTL 1, emotion data such as “happiness”, “smile”, “anger”, and “sadness” is acquired by performing emotion recognition based on an amount of change of a voice strength, a voice generation rate, a strength of each word, volume, and voice spectrum and customer satisfaction is calculated based on the emotion data.

However, in the method which uses the amount of change of the voice strength as in the related art described above, there is a possibility that it is possible to ascertain emotions of a person to some point, but it is not possible to ascertain a relationship of the emotions and sales and the like, and it is difficult to appraise wording during customer service largely related to the quality of customer service attitude of employees or the like.

The present invention is carried out in consideration of the problems of the related art, and the main advantage is to provide a customer service appraisal device which is able to appropriately appraise a customer service attitude of a person based on voice of the person during customer service, a customer service appraisal system, and a customer service appraisal method.

According to the present invention, there is provided a customer service appraisal device which appraises the customer service attitude of a person, the device including a voice input terminal in which voice of the person is input as a voice signal, a keyword detector which detects one or more predetermined customer service keywords from voice of the person by acquiring the voice signal, a voice feature acquirer which acquires a voice feature of the customer service keyword that is detected by the keyword detector, a voice feature difference calculator which calculates a difference value between the voice feature that is acquired by the voice feature acquirer and a predetermined prescribed voice feature, and an appraisal value calculator which calculates an appraisal value that is an indicator of good or bad of the customer service attitude of the person based on the difference value.

According to the present invention, it is possible to appropriately appraise a customer service attitude of a person based on voice of the person during customer service.

### BRIEF DESCRIPTION OF DRAWINGS

FIG. 1 is a configuration diagram of the entirety of a customer service appraisal system according to an embodiment of the present invention.

FIG. 2 is a functional block diagram illustrating a customer service appraisal device and peripheral equipment in the customer service appraisal system indicated in FIG. 1.

FIG. 3 is a flowchart illustrating flow of a production process of keyword detection information in a process for customer service scoring by the customer service appraisal device.

FIG. 4 is an explanatory diagram illustrating an example of a customer service keyword list which is used by the customer service appraisal device.

FIG. 5 is a flowchart illustrating flow of a calculation process of a customer service score in a process for customer service scoring.

FIG. 6 is an explanatory diagram illustrating an example of a voice feature value which is calculated by the customer service appraisal device.

FIG. 7 is an explanatory diagram illustrating an example of a process result (calculation result of customer service score) of step ST205 in FIG. 5.

FIG. 8 is a flowchart illustrating flow of a learning process of a customer service keyword in the customer service appraisal device.

FIG. 9 is a flowchart illustrating flow of a correction process with a weighting coefficient which is used in calculation of a customer service score in the customer service appraisal device.

FIG. 10 is an explanatory diagram illustrating an example of a correction process with a weighting coefficient which is used in calculation of a customer service score.

### DESCRIPTION OF EMBODIMENT

According to a first invention which is carried out in order to solve the problem described above, there is provided a customer service appraisal device which appraises the customer service attitude of a person, the device including a voice input terminal in which voice of the person is input as a voice signal, a keyword detector which detects one or more predetermined customer service keywords from voice of the person by acquiring the voice signal, a voice feature acquirer which acquires a voice feature of the customer service keyword that is detected by the keyword detector, and an appraisal value calculator which calculates an appraisal value that is an indicator of good or bad of the customer service attitude of the person based on a comparison with a voice feature that is acquired by the voice feature acquirer and a predetermined prescribed voice feature.

According to the customer service appraisal device according to the first invention, it is possible to appropriately appraise the customer service attitude of the person based on voice of the person during customer service. In addition, even in the same customer service keyword, it is possible to appraise the customer service attitude according to voice of the shop assistant by using the prescribed voice feature matched with characteristics of the store.

In addition, a second invention, according to the first invention, further includes a voice feature difference calculator which calculates a difference value between the voice feature that is acquired by the voice feature acquirer and a predetermined prescribed voice feature, in which the appraisal value calculator calculates the appraisal value based on the difference value.

According to the customer service appraisal device according to the second invention, it is possible to easily appraise good or bad of the customer service attitude by calculating the appraisal value using the difference value of the voice feature value and the prescribed voice feature value.

In addition, in a third invention, according to the second invention, the prescribed voice feature is a voice feature that is predetermined for each customer service keyword and preferred as the customer service keyword, and in the calculation of the appraisal value, the smaller the difference the better the customer service attitude of the person is appraised.

According to the customer service appraisal device according to the third invention, it is possible to appraise the customer service attitude to be good when the voice feature of the shop assistant is closer to the prescribed voice feature (difference is small) which is a preferred voice feature that is to be a model.

In addition, in a fourth invention, according to the second invention, the prescribed voice feature is a voice feature that is predetermined for each customer service keyword and standard as the customer service keyword, and in the calculation of the appraisal value, in a case where the difference value is large in a positive direction, the customer service attitude of the person is appraised to be good, and in a case where the difference value is large in a negative direction, the customer service attitude of the person is appraised to be bad.

According to the customer service appraisal device according to the fourth invention, it is possible to clearly determine good or bad of the customer service attitude according to the voice feature of the shop assistant since the customer service attitude is appraised to be good if the voice feature of the shop assistant is a threshold or above and the customer service attitude is appraised to be bad if the voice feature of the shop assistant is less than the threshold using a prescribed voice feature as the threshold.

In addition, in a fifth invention, according to the first to fourth inventions, the customer service keywords are grouped for each application, and the prescribed voice feature of the customer service keywords belonging to the same group is provided with a common predetermined voice feature.

According to the customer service appraisal device according to the fifth invention, it is possible to set an appropriate voice feature according to a case where the customer service keyword is used and calculate the appraisal value of the customer service attitude based thereon since the customer service keywords are grouped into a customer service keyword group for greetings, a customer service keyword group for apologizing, and the like, and the prescribed voice features of the customer service keywords within the groups have a common voice feature.

In addition, in a sixth invention, according to the first to fifth inventions, the prescribed voice feature is provided with a predetermined voice feature with respect to a specific word in a case where the specific word which is a predetermined word is included in a portion of customer service keywords.

According to the customer service appraisal device according to the sixth invention, in a case where a specific word in which a recommended product name, a membership card name, and the like are particularly coordinated is included within the customer service keywords, it is possible to set an appropriate voice feature that clarifies the word to be emphasized and calculate the appraisal value of the customer service attitude based thereon since a part of the specific words of the prescribed voice feature is provided with a distinct voice feature.

In addition, in a seventh invention, according to any one of the first to sixth inventions, the prescribed voice feature is predetermined as a male voice or a female voice in each customer service keyword, use of the prescribed voice feature according to the male voice and use of the prescribed voice feature according to the female voice are switched according to the voice of the person, and the difference value is calculated.

According to the customer service appraisal device according to the seventh invention, it is possible to correctly calculate the appraisal value of the customer service attitude based on the prescribed voice feature that is appropriate to the gender since there are respective prescribed voice features in a male voice and a female voice that have inherently different voice features and are switched to be matched with the voice of the person.

In addition, in an eighth invention, according to any one of the first to seventh inventions, the appraisal value calculator calculates the appraisal value based on the sum of the difference value that is weighted in each type of the voice feature.

According to the customer service appraisal device according to the eighth invention, it is possible to more appropriately calculate the appraisal value that is an indicator of good or bad of the customer service attitude by weighting in each type of the voice feature.

In addition, a ninth invention, according to the eighth invention, further includes a voice feature weighting decider which dynamically changes a weighting coefficient of the weighting for each type of the voice feature based on a learning function.

According to the customer service appraisal device according to the ninth invention, it is possible to more appropriately perform weighting in each type of the voice feature.

In addition, in a tenth invention, according to any one of the first to ninth inventions, the voice feature includes at least one of tone of voice, speed of voice, volume of voice, emotion, and smiling voice.

According to the customer service appraisal device according to the tenth invention, it is possible to appropriately calculate the appraisal value that is an indicator of good or bad of the customer service attitude based on any voice feature of the customer service keyword.

In addition, in an eleventh invention, according to any one of the first to tenth inventions, the appraisal value calculator reflects a detection amount of the customer service keyword that is detected by the keyword detector in the appraisal value.

According to the customer service appraisal device according to the eleventh invention, it is possible to more appropriately appraise the customer service attitude since the detection amount of the customer service keyword is reflected in the appraisal value as an indicator of good or bad of the customer service attitude.

In addition, in a twelfth invention, according to the eleventh invention, the detection amount of the customer service keyword is a detection number of the customer service keyword that is detected per predetermined unit time or unit event.

According to the customer service appraisal device according to the twelfth invention, it is possible to appropriately calculate the appraisal value that is an indicator of good or bad of the customer service attitude based on an appropriate voice feature of the customer service keyword.

In addition, in a thirteenth invention, according to the twelfth invention, the appraisal value calculator calculates the appraisal value based on the sum of the detection number of the customer service keyword that is weighted in each type of customer service keyword.

According to the customer service appraisal device according to the thirteenth invention, it is possible to more appropriately calculate the appraisal value that is an indicator of good or bad of the customer service attitude by weighting in each type of customer service keyword.

In addition, a fourteenth invention, according to the thirteenth invention, further includes a keyword weighting decider which dynamically changes a weighting coefficient of the weighting for each type of customer service keyword based on a learning function.

According to the customer service appraisal device according to the fourteenth invention, it is possible to more appropriately perform weighting in each type of customer service keyword.

In addition, in a fifteenth invention, according to the first or eleventh invention, the keyword detector detects the customer service keyword in a predetermined period of time with a time of a previous customer visit as a reference.

According to the customer service appraisal device according to the fifteenth invention, it is possible to more appropriately appraise the customer service attitude since only the customer service keyword that is generated when there is actually a customer visit is an appraisal target.

In addition, a sixteenth invention, according to the first invention, further includes a data input terminal in which sales data according to customer service of the person is input and a display which displays correlation between the sales data and the appraisal value.

According to the customer service appraisal device according to the sixteenth invention, it is possible to display sales performance and customer service attitude of the employees in association.

In addition, according to a seventeenth invention, there is provided a customer service appraisal system including the customer service appraisal device according to any one of the first to sixteenth inventions, and a management apparatus which is connected to be able to communicate with the customer service appraisal device via a network and which receives information including at least the appraisal value from the customer service appraisal device.

In addition, according to an eighteenth invention, there is provided a customer service appraisal method which appraises the customer service attitude of a person, the method including inputting voice of the person as a voice signal, detecting one or more predetermined customer service keywords from voice of the person by acquiring the voice signal, acquiring a voice feature of the detected customer service keyword, and calculating an appraisal value that is an indicator of good or bad of the customer service attitude of the person based on a comparison with the acquired voice feature and a predetermined prescribed voice feature.

In addition, a nineteenth invention, according to the eighteenth invention, further includes calculating a difference value between the acquired voice feature and the predetermined prescribed voice feature, and calculating the appraisal value based on the difference value.

In addition, a twentieth invention, according to the eighteenth or nineteenth invention, further includes detecting the customer service keyword in a predetermined period of time with a time of a customer visit as a reference from speech of the person.

An embodiment of the present invention will be described below with reference to the drawings.

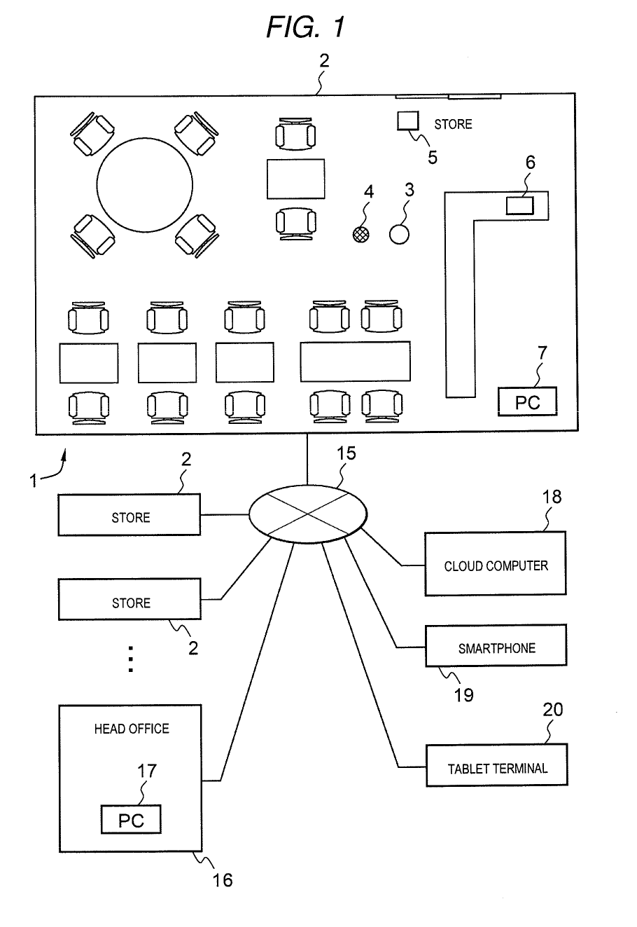

FIG. 1 is a configuration diagram of the entirety of customer service appraisal system 1 according to an embodiment of the present invention. Customer service appraisal system 1 is constructed with respect to a plurality of stores 2 of, for example, a restaurant chain, and store 2 includes camera 3 which images the inside of the store, microphone 4 which collects voice within the store, sensor 5 which detects a customer who visited store 2, point of sale (POS) apparatus 6 which is able to acquire various data (sales data and the like) with respect to sales and customer attraction in store 2, and customer service appraisal device 7 which appraises the customer service attitude of the shop assistant (customer service agent such as an employee) in store 2. Camera 3, microphone 4, sensor 5, and POS apparatus 6 are able to directly or indirectly communicate with customer service appraisal device 7 via a communication line such as a local area network (LAN) which is not shown in the drawings. In FIG. 1, only one store 2 which is positioned in a top portion is indicated with a detailed configuration, but other stores have the same configuration.

Camera 3 is an omnidirectional camera which is installed on the ceiling within a store, and a video which is imaged by camera 3 is sent to customer service appraisal device 7 via the communication line as a video signal. The video which is imaged by camera 3 is a video which mainly includes a person (shop assistant or customer). As long as camera 3 is able to image at least a customer service operation of the shop assistant or an operation of the customer to whom service is provided (including facial expression and the like of the shop assistant or customer), the type, disposition, quantity, and the like are not particularly limited, and may be variously modified.

Microphone 4 is an omnidirectional microphone which is installed on the ceiling within the store, and voice which is collected by microphone 4 is sent to customer service appraisal device 7 via the communication line as a voice signal. The voice which is collected in the microphone 4 is voice mainly of the person (shop assistant or customer). As long as microphone 4 is able to collect voice of at least the shop assistant, the type, disposition, quantity, and the like are not particularly limited, and may be variously modified.

Sensor 5 is a motion sensor which is installed in the ceiling near the entrance within the store (here, an infrared sensor), the detection signal of sensor 5 is sent to customer service appraisal device 7 via the communication line, and thereby, the number of customers visiting is counted. The number of customers visiting is not necessarily based on a detection result by sensor 5, and for example, may be counted from an input result of POS apparatus 6.

POS apparatus 6 is made from a POS register which is utilized in adjustment and the like of a fee of the customer who utilizes store 2, and sales data which is input to POS apparatus 6 is sent to customer service appraisal device 7 via the communication line. Not only data of price and the like that is obtained by selling a product is in the sales data, but various associated data such as data which relates to a customer who purchases the product and the shop assistant who gives customer service to the customer is included in the sales data.

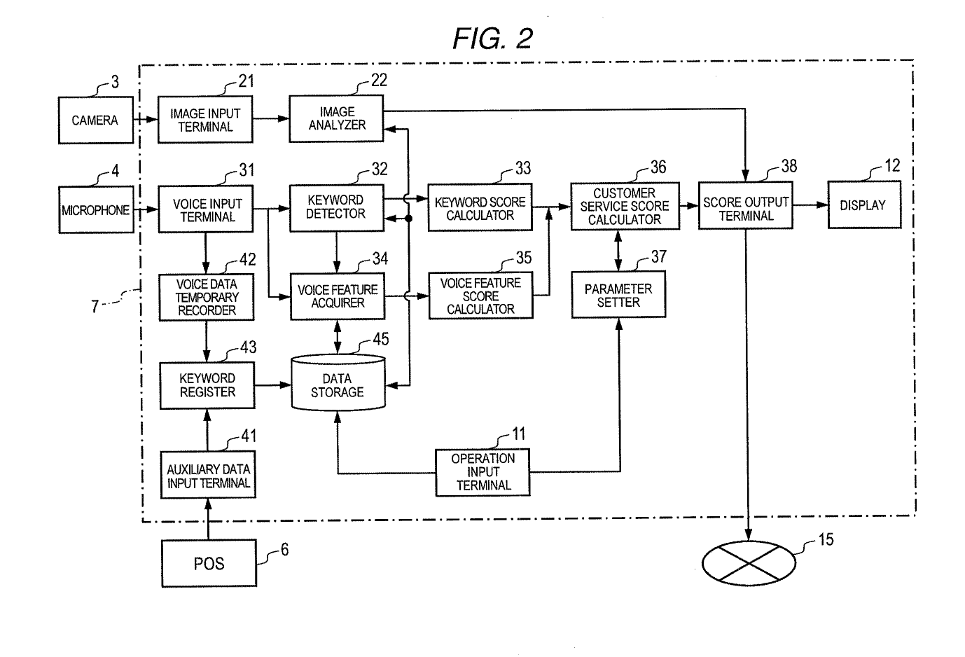

Customer service appraisal device 7 is installed in store 2, and is a personal computer (PC) which is used by a user such as a store manager, and although not described in detail, is provided with a well-known peripheral such as a printer or a recorder, in addition to operation input terminal 11 such as a keyboard or mouse which performs a variety of input operations and display 12 (refer to FIG. 2) that is made from a monitor which displays a monitoring screen. As will be described later, customer service appraisal device 7 acquires the video from camera 3, voice from microphone 4, and sales data from POS apparatus 6, and executes a sequence of information processing (hereinafter referred to as “customer service scoring”) for calculating the appraisal value (hereinafter referred to as “customer service score”) that is an indicator of good or bad of the customer service attitude of the shop assistant. In addition, in order for the user to monitor within the store, customer service appraisal device 7 is able to display the video within the store which is imaged by camera 3 on display 12, and output voices collected within the store by microphone 4 from a speaker and the like.

Customer service appraisal device 7 is able to communicate with a well-known communication device such as smartphone 19 or tablet terminal 20 in addition to a customer service appraisal device which is not shown in the drawings in another store, and head office PC (management apparatus) 17 which is provided in head office 16 that overviews a plurality of stores 2, and cloud computer 18 via wide area network 15. Head office PC 17 is able to execute customer service scoring in cooperation with customer service appraisal device 7 by acquiring information and the like which relates to the customer service appraisal that is obtained by processing information on the video, voice, and sales data from customer service appraisal device 7 in each store 2.

In addition, customer service appraisal device 7 is able to display the customer service score of each shop assistant on a graph or the like, display in correlation a customer service score and customer service time of each shop assistant and sales data of the shop assistant, and statistically display an average value of the customer service score, sales data, and the like of each store on display 12.

Customer service scoring which is executed by customer service appraisal device 7 and head office PC 17 in the present embodiment is not necessarily limited to sharing of each process between customer service appraisal device 7 and head office PC 17, and a process (at least a part) which is to be executed by an apparatus of a part thereof is also able to be executed as an alternative by another apparatus. For example, customer service appraisal device 7 may execute customer service scoring and transmit only a result of customer service scoring (customer service score) to head office PC 17. Alternatively, customer service appraisal device 7 may transmit various information that is necessary in customer service scoring to head office PC 17, and head office PC 17 may execute customer service scoring. In addition, customer service appraisal device 7 of some store 2 may perform the same function as head office PC 17.

FIG. 2 is a functional block diagram illustrating customer service appraisal device 7 and a peripheral thereof in customer service appraisal system 1 indicated in FIG. 1.

Customer service appraisal device 7 is provided with image input terminal 21 which inputs video from camera 3 as a video signal and image analyzer 22 which performs image analysis of the input video, and is able to utilize an analysis result of the video of the shop assistant and the like within the store in customer service scoring.

In addition, customer service appraisal device 7 is provided with voice input terminal 31 which inputs voice from microphone 4 as the voice signal, keyword detector 32 which detects one or more predetermined customer service keywords from the input voice, keyword score calculator 33 which calculates numerical data (hereinafter referred to as “keyword score”) which is used in calculation of customer service score that is an indicator of good or bad of the customer service attitude based on the customer service keyword that is detected by keyword detector 32, voice feature acquirer 34 which acquires voice feature value (including a vector according to need) of the customer service keyword that is detected by keyword detector 32, voice feature score calculator (voice feature difference calculator) 35 which calculates numerical data (hereinafter referred to as “voice feature score”) which is used in calculation of the customer service score based on the voice feature value which is acquired by voice feature acquirer 34, customer service score calculator (appraisal value calculator) 36 which calculates the customer service score based on the keyword score and the voice feature score, and parameter setter 37 which sets a parameter (weighting coefficient which is used in calculation of the customer service score, a correction value thereof, and the like) which is used in calculation of the customer service score by customer service score calculator 36, and is able to execute customer service scoring based on voice of the shop assistant within the store.

In the present embodiment, a word which is preferable for the shop assistant to use for the purpose of customer service or a sales promotion is set as the customer service keyword to be detected, but the customer service keyword is not necessarily limited thereto, and is able to be variously modified according to a sales mode of the store or a customer base. In addition, according to the case, a configuration is possible in which the word that is not suitable to be used by the shop assistant for the purpose of customer service and sales promotion is set as the customer service keyword.

In customer service appraisal device 7, customer service score which is calculated by customer service score calculator 36 is output to display 12 or an external unit (another apparatus connected to wide area network 15) by score output terminal 38.

In addition, auxiliary data input terminal 41 in which auxiliary data (for example, sales data, customer service time, and information on the customer service attitude that is separately collected) for customer service scoring is input from POS apparatus 6, voice data temporary recorder 42 which temporarily records voice that is input to voice input terminal 31, and keyword register 43 which extracts voice during customer service of the shop assistant from voice that is recorded on voice data temporary recorder 42 and sets the voice as customer service keywords in a case where good and bad of the customer service attitude of the shop assistant is determined based on auxiliary data which is input to auxiliary data input terminal 41 and the customer service attitude is determined to be favorable are provided in customer service appraisal device 7. Due to such a configuration, the learning function of the customer service keyword in customer service appraisal device 7 is realized.

In customer service appraisal device 7, the customer service keyword (reference information of the customer service keyword that is to be detected by keyword detector 32) which is used in customer service scoring, a voice feature value in which the voice feature is digitized, and various data such as auxiliary data (including data that is newly generated or set) are appropriately stored in data storage 45 made from a memory.

Customer service appraisal device 7 as well-known hardware, is provided with CPU (arithmetic processing unit) which integrally controls apparatuses, RAM which functions as a work memory, HDD as a storage device which stores a program for customer service scoring that is able to execute customer service scoring, and the like. Thereby, processing of each unit in customer service appraisal device 7 is executed by executing (software processing) of a program for customer service scoring by CPU. Alternatively, a configuration is possible in which a portion of processes of each unit is executed by hardware.

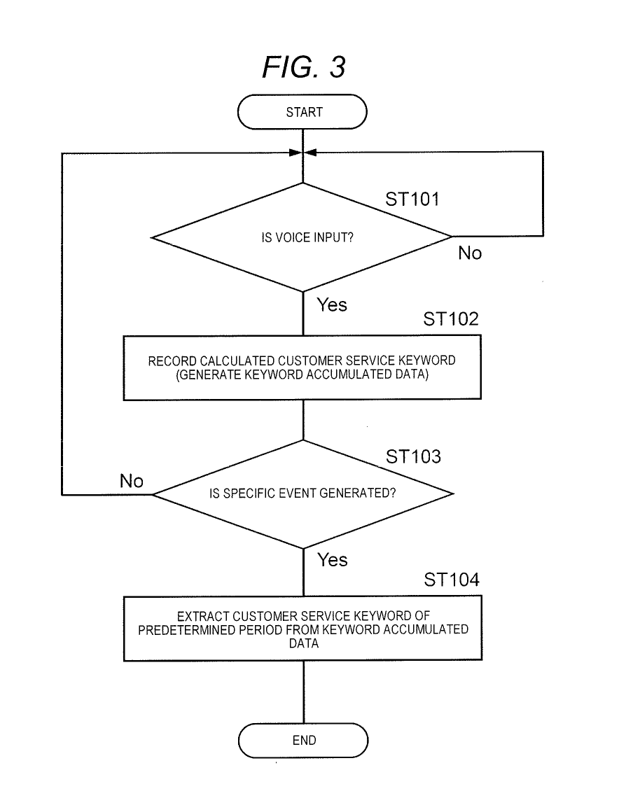

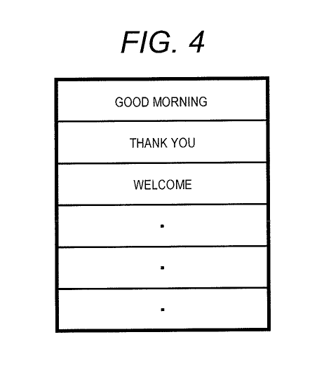

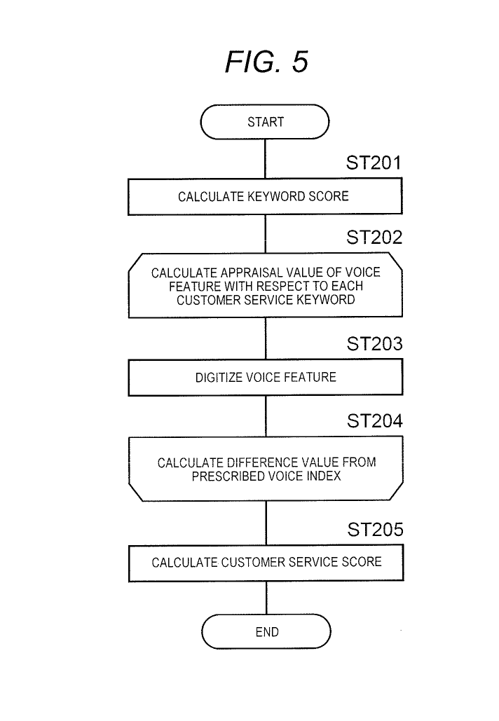

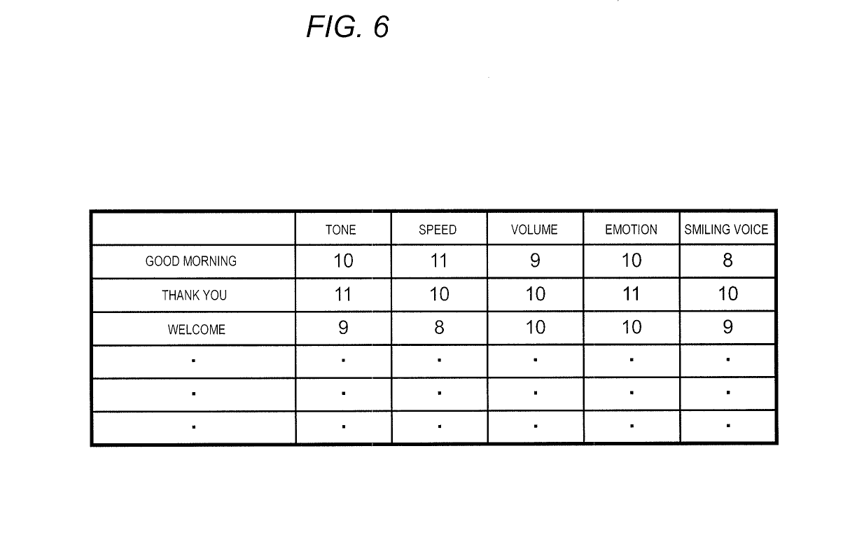

FIG. 3 is a flowchart illustrating flow of a production process of keyword detection information in a process for customer service scoring by customer service appraisal device 7 indicated in FIG. 2, FIG. 4 is an explanatory diagram illustrating an example of a customer service keyword list which is used by customer service appraisal device 7, FIG. 5 is a flowchart illustrating flow of a calculation process of a customer service score in a process for customer service scoring, and FIG. 6 is an explanatory diagram illustrating an example of a voice feature value which is calculated by customer service appraisal device 7.

As shown in FIG. 3, in a generation process of the keyword detection information, when voice is input from microphone 4 in voice input terminal 31 (ST101: Yes), keyword detector 32 determines whether or not the customer service keyword is included in input voice based on reference information which is stored in data storage 45 and in a case where it is determined that the customer service keyword is included, the detected customer service keyword and associated information (voice data, detection time, and the like of the customer service keyword) are recorded in data storage 45 as keyword accumulated data (ST102). In a case where a customer voice is input along with a shop assistant voice, since the target of keyword detection is a shop assistant voice in step ST101, keyword detector 32 is able to execute a process of extracting only the shop assistant voice by executing a matching process of input voice based on a prerecorded shop assistant voice.

Here, as shown in FIG. 4, a list of the customer service keyword (here, “good morning”, “thank you”, “welcome”, and the like which is necessary in customer service of store 2) that is to be detected by keyword detector 32 is prerecorded in data storage 45 as reference information. Keyword detector 32 is able to determine whether or not the customer service keyword is included in the input voice by referencing the list. It is possible for the user (here, manager of store 2) to add or delete the customer service keywords included in the list from operation input terminal 11 according to need, or is able to add or delete according to the learning function of customer service appraisal device 7 described later.

Next, keyword detector 32 determines whether or not a predetermined specific event is generated (ST103), in a case where keyword detector 32 determines that the specific event (for example, a customer visit) is generated (Yes), the customer service keyword that is detected in a predetermined period of time (for example, predetermined period of time prior to and after time T1) which is set with reference to generation time T1 of the specific event and associated information are extracted as keyword detection information and recorded in data storage 45 in the keyword accumulated data (ST104). In step ST103, in a case where it is determined that the specific event is not generated, the process returns to step ST101 again.

In the process of customer service scoring by customer service appraisal device 7, the customer service keyword and associated information are gradually accumulated as keyword detection information by a generation process of such keyword detection information, and the calculation process of the customer service score is executed in a state in which accumulation is sufficient. In this case, keyword detector 32 is able to record the customer service keyword and the associated information which are accumulated as keyword detection information by dividing those into a plurality of sets at each predetermined unit time (detection period).

As shown in FIG. 5, in the calculation process of the customer service score, keyword score calculator 33 calculates a detection number of the customer service keyword that is detected per predetermined unit time (for example, one hour, one day, one week, and the like) as a keyword score in the keyword detection information (ST201).

Keyword score calculator 33 may set a value that is obtained by dividing the detection number of the customer service keyword which is detected per unit time by the number of customer visits per unit time as a keyword score. Thereby, even in a case where there is a large difference in the number of customer visits in each store 2, it is advantageous in that the customer service score described later is more appropriately calculated. In addition, here the keyword score is set as the detection number of the customer service keyword that is detected per unit time, but is not limited thereto, and the detection number of the customer service keyword that is detected per unit event (for example, the customer visits the store one time, and adjustment one time of a customer) may be set as the keyword score. In this case, customer store visits and adjustment are able to be detected according to a detection result of sensor 5, an input result of POS apparatus 6, an analysis result of image analyzer 22, or the like.

Next, in the calculation process of the customer service score, the voice feature score is calculated based on the voice feature value which is acquired by voice feature acquirer 34 (ST202 to ST204). First, in calculation of the voice feature score, voice feature acquirer 34 digitizes the voice feature of the customer service keyword that is included in the keyword detection information, and records the number value as the voice feature value (ST203). Here, for example, as shown in FIG. 6, items such as tone of voice, speed of voice, volume of voice, emotion (“happiness”, “anger”, “sadness”, and the like that are determined based on correlation of emotion and voice of the person), and smiling voice (voice generated by a person in a smiling state) are included in the voice feature of the customer service keyword, a part or all items are digitized by a known method to be voice feature values (number values indicated within FIG. 6).

Voice feature acquirer 34 does not necessarily use the keyword detection information described above, for example, it is also possible to acquire the detection data of the customer service keyword from keyword detector 32 and digitize the voice feature of the customer service keyword, thereby recording the number value as the voice feature value, during detection of the customer service keyword by keyword detector 32 in step ST102 of FIG. 3 described above. In addition, the voice feature of the customer service keyword is not limited to the indication here, and various modifications are possible.

Next, voice feature score calculator 35 calculates the voice feature score which is used in calculation of the customer service score based on the voice feature value which is acquired by voice feature acquirer 34 (ST204). Here, a reference value (prescribed voice feature value) of the voice feature value which represents a reference (prescribed voice feature) of the voice feature of each customer service keyword is prerecorded in data storage 45, and the reference value (prescribed voice feature value) is made from the voice feature value in which the voice feature of the customer service keyword is digitized, and is set corresponding to each item (tone, speed, volume, emotion, smiling voice) of the voice feature value indicated in FIG. 6.

The prescribed voice feature value is able to be arbitrarily modified according to the store. Even if the customer service keyword is the same as “welcome”, “welcome” in a quiet restaurant, a department store, and a hotel, and “welcome” in a lively tavern, a gas station, and a pachinko parlor necessarily have different voice features.

In addition, even if the prescribed voice feature value is the same customer service keyword in a different store of the same chain or the same store, a plurality of prescribed voice feature values may be prepared according to the circumstance of the day of the week, time, congestion, and the like, and may be able to be arbitrarily modified according to the circumstance. For example, since a weekday is a quiet environment, the volume of voice may be suppressed, but since a weekend day is a lively environment due to congestion, the volume of voice is higher than on a week day. Alternatively, the prescribed voice feature may be modified according to a period of time such as day time and night time, and the manager of the store may modify the prescribed voice feature according to the circumstance of the place of the store.

In the embodiment of the present invention, it is possible for the prescribed voice feature value that matches the characteristic or environment of the store to be stored in advance in data storage 45, and to appropriately appraise the customer service attitude according to voice of the shop assistant by comparing the prescribed voice feature value and the voice feature of the voices that are actually generated by the shop assistant.

Furthermore, the prescribed voice feature value may be respectively prepared according to a male voice and according to a female voice, and the male prescribed voice feature value and the female prescribed voice feature value may be switched by determining whether the shop assistant is male or female according to the voice of the shop assistant.

Since a male shop assistant and a female shop assistant have different customer service voice features, it is possible for the prescribed voice feature value that matches the gender to be stored in advance in data storage 45, and to appropriately appraise the customer service attitude according to voice of the shop assistant based on the prescribed voice feature value that matches the gender by comparing with the prescribed voice feature value.

Furthermore, in a case where a specific word that is to be clearly conveyed with a particular emphasis is included in a part of the customer service keywords, the prescribed voice feature value to which the voice feature inherent to the specific word is applied is prepared. For example, in a case where “do you have an AA card?” is registered as the customer service keyword, a membership card name of the store of “AA card” within the customer service keyword is set as the prescribed voice feature value that has the voice feature inherent to the specific word in the part of “AA card” of the customer service keyword as the “specific word” that is to be clearly, slowly, and loudly spoken such that the customer is necessarily audible.

In addition, in addition to the membership card name, a recommended product name, campaign product name, and the like may be the specific word. In this case, there is a voice feature inherent to the specific word in the part of the product name of “BB” within the customer service keyword of “How about BB as well?”. The prescribed voice feature value of all customer service keywords which include the specific word may be stored in advance in data storage 45 in comparison to the prescribed voice feature value, or a list of the specific word (“AA card”, “BB”) and the prescribed voice feature value common to the specific word may be stored, the specific word may be detected to be included within the customer service keyword, and part of the specific words may be compared to the prescribed voice feature value common to the specific word. By setting the specific word, it is possible to appropriately appraise the customer service attitude according to the voice of the shop assistant based on the prescribed voice feature which relates to the word which is emphasized by the store.

Next, in step ST204, concerning the customer service keyword, voice feature score calculator 35 sets a difference (here, an absolute value) between a number value of each item of the voice feature value (refer to FIG. 6) which is acquired in step ST203 and a reference value (prescribed voice feature value) of an item corresponding to the voice feature value, and calculates the difference as the voice feature score.

The prescribed voice feature value may be provided with a voice feature which is common according to the application of the customer service keyword. That is, “good morning” or “welcome” is recorded as the customer service keyword for greeting, and “excuse me” or “sorry” is recorded as the customer service keyword for apologizing.

In the customer service keyword for greeting and the customer service keyword for apologizing, the voice features are different as a matter of course. For example, the customer service keywords that are grouped for greeting are provided with the prescribed voice feature which is spoken with a bright tone at a speed with energy in loud voice, and the customer service keywords which are grouped for apologizing are provided with the prescribed voice feature which is spoken to be apologetic at a low tone at a calm speed.

The customer service keywords which are stored in data storage 45 may be stored collectively in each group that has common voice features, and may be stored in alphabetical order or registration order and provided with respective group identifiers. By setting in this manner, all or a part of the prescribed voice feature value of the customer service keywords which belong to the group is common.

When describing an operation in this case, prior to ST204 in FIG. 5, the group of the customer service keywords is specified, in a case where the group is specified, in place of step ST204, a difference value of the number value of each item of the voice feature value (refer to FIG. 6) that is acquired in step ST203 and the number value of each item of the prescribed voice feature value common to the group is calculated, and the process proceeds to step ST205. Meanwhile, in a case where the group is not specified (not belonging to a group), in step ST204, the difference value of the number value of each item of the voice feature value (refer to FIG. 6) that is acquired in step ST203 and the number value of each item of the prescribed voice feature value of the individual extracted customer service keyword is calculated, and the process proceeds to step ST205. In this manner, it is also possible to reduce a storage amount of data storage 45 by the prescribed voice feature value being common.

In addition, the prescribed voice feature value holds the voice feature that is preferable to be model voice, the voice feature score at which the difference between the voice feature value of the shop assistant and the prescribed voice feature value per calculation of the voice feature score is small (close as possible to the prescribed voice feature value) is set to a score at which the customer service attitude is good, and the difference that is large is set to a score at which the customer service attitude is bad.

In addition, in place of the above, the prescribed voice feature value may hold the voice feature that is to be an average reference, the voice feature score at which the difference between the voice feature value of the shop assistant and the prescribed voice feature value per calculation of the voice feature score is large in a positive (+) direction (exceeding the prescribed voice feature value as much as possible) may be set to a score at which the customer service attitude is good, and the difference that is large in a negative (−) direction (falling below the prescribed voice feature value as much as possible) may be set to a score at which the customer service attitude is bad. At that time, the appraisal value is added by as much as the difference is large in the positive (+) direction, the appraisal value is subtracted by as much as the difference is large in the negative (−) direction, and the high appraisal value may be set as good customer service attitude.

In addition, there is a possibility that weighting is performed with respect to the difference which relates to each item per calculation of the voice feature score. For example, there is a possibility that weighting coefficients are respectively set with respect to each item of tone of voice, speed of voice, volume of voice, emotion, and smiling voice, and a sum after the weighting coefficients are multiplied with each difference value with respect to each item is calculated as the voice feature score. In addition, voice feature score calculator 35 may set a value (average value) obtained by dividing the voice feature score that is calculated in step ST204 by the number of customer visits (or the number of the customer service keywords that is used in the voice feature score) as the voice feature score. Thereby, even in a case where there is a large difference in the number of customer visits in each store 2, it is advantageous in that the customer service score is more appropriately calculated.

After that, customer service score calculator 36 calculates the customer service score by adding the keyword score that is calculated in step ST201 and the keyword score that is calculated in step ST204 (ST205). There is a possibility that voice feature score calculator 35 performs respective weighting with respect to the difference value of each item of the keyword score and the voice feature score per calculation of the customer service score.

In customer service score calculator 36, in a configuration in which a word that is not suitable to be used by the shop assistant for the purpose of customer service or a sales promotion as described above is set as the customer service keyword, the customer service score may be calculated by subtracting the keyword score from a predetermined number value (perfect score) and a calculated deduction score from the voice feature score.

The customer service score which is calculated in a calculation process of the customer service score as described above is sent to score output terminal 38. Score output terminal 38 generates display data for displaying the customer service score in another apparatus (head office PC 17, smartphone 19, tablet terminal 20, and the like) connected to display 12 or wide area network 15 and transmits the display data with respect to the other apparatus which is connected to display 12 or wide area network 15.

As a display method of customer service appraisal of a customer service appraisal result (customer service score) in the other apparatus which is connected to display 12 or wide area network 15, it is possible to adopt a graph display (bar chart, pie chart, and line graph), a list display, and the like. In addition, the customer service score is able to be displayed as an individual score of each shop assistant (employee), each store, and the like.

In the display method of the individual score, for example, in the bar chart display, it is possible to set an X axis as each shop assistant, each store, each region (store location), each store owner, each store instructor, or each period, and a Y axis as a customer service score, a keyword score, or a voice feature score. In addition, for example, in the list display, it is possible to display the customer service score sorted in high order or low order, or in high order or low order of the keyword score or the voice feature score.

In addition, in the display method of the customer service appraisal, a proportion which occupies configuring elements of the customer service score (here, keyword score and voice feature score) may be displayed. For example, in the pie chart display, it is possible to display configuring elements of the customer service score (here, keyword score and voice feature score), each voice feature (tone of voice, speed of voice, volume of voice, emotion, smiling voice, and the like), and the like.

In addition, in the display method of customer service appraisal, in particular, a value of the customer service score with respect to sales of the store (that is, correlation of sales and customer service score) may be displayed. Alternatively, in the line graph display, it is possible to set the X axis as the customer service score of each store, each region, each time, or each weekday, and set the Y axis as sales (total sales of the store, sales of each product category, and the like). Thereby, the user is able to ascertain correlation of sales of the store and a value of the customer service score.

In addition, in the display method of customer service appraisal, in particular, correlation of the customer service score and repeat rate of the customer may be displayed. For example, in the line graph display, it is possible to set the X axis as the customer service score of each store, each region, each time, or each weekday, and set the Y axis as repeat rate (age group, gender, product category, and the like). Thereby, the user is able to ascertain correlation of a repeat rate of the customer and a value of the customer service score.

In addition, another apparatus which is connected to display 12 or wide area network 15 may display an alert in a case where the number value of the customer service score is out of a target range (a case of being lower or a case of being higher than a predetermined threshold). It is possible to perform display of such an alert to each employee or each store.

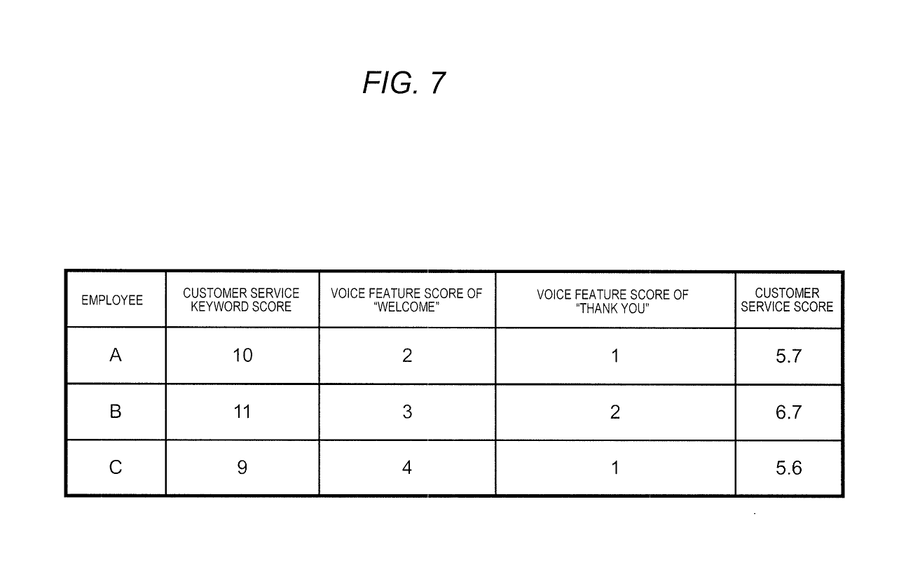

FIG. 7 is an explanatory diagram illustrating an example of a process result (calculation result of customer service score) of step ST205 in FIG. 5. Here, customer service keywords “welcome” and “thank you” indicate an example in which the customer service score is calculated from the keyword score and the voice feature score. The customer service score (S) is calculated by the following equation.

customer service score (S)=α×K+β1×AD1+β2×AD2

However, α, β1, β2: weighting coefficient, K: keyword score, AD1: voice feature score of first customer service keyword “welcome”, and AD2: voice feature score of second customer service keyword “thank you”.

For example, when employee A of FIG. 7 sets the keyword score and the voice feature score to K=10, AD1=2, and AD2=1, and sets the weighting coefficient α=0.5, β1=0.2, and β2=0.3, customer service score (S)=5.7 is calculated. Customer service scores of employees B and C are able to be calculated in the same manner.

Customer service score calculator (keyword weighting decider and voice feature weight decider) 36 is able to dynamically modify the weighting coefficient in each type of customer service keyword based on the learning function, or is able to dynamically modify the weighting coefficient in each type of the voice feature based on the learning function. In this case, it is possible to set a configuration in which the user sets a target value with respect to the statistical value (for example, average value) of the customer service score, and for customer service score calculator 36 to set the weighting coefficient such that the statistical value of the customer service score comes close to the target value.

In addition, in a case where there is a possibility that detection precision in keyword detector 32 is affected by calculation of the customer service score, the weighting coefficient of the keyword score and the voice feature score may be set from a viewpoint of compensating the detection precision in keyword detector 32.

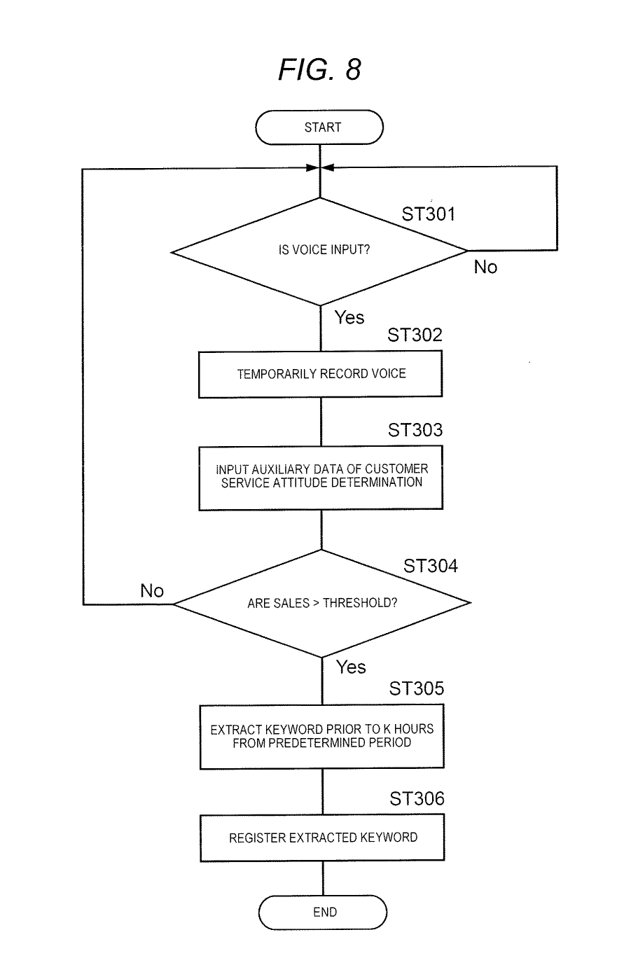

FIG. 8 is a flowchart illustrating flow of a learning process of a customer service keyword in customer service appraisal device 7. As shown in the drawing, in the learning process of the customer service keyword, when voice from microphone 4 is input to voice input terminal 31 (ST301: Yes), voice data temporary recorder 42 temporarily records the input voice (ST302). Next, auxiliary data (here, sales data) for customer service scoring is input with respect to auxiliary data input terminal 41 from POS apparatus 6 (ST303).

After that, keyword register 43 determines whether or not sales data which is input to auxiliary data input terminal 41 exceeds a predetermined threshold (ST304) and in a case where the sales data exceeds the threshold (Yes), an extraction process of the keyword is executed based on a well-known method from the voice (voice which is temporarily recorded in voice data temporary recorder 42) which is input to a predetermined period of time prior to time T2 with the determination time T2 as a reference (ST305). Meanwhile, in a case where the sales data does not exceed the threshold (ST304: No), the process returns to step ST301 again.

After that, keyword register 43 newly records (adds) an extracted keyword in step ST305 in a list of data storage 45 as a customer service keyword that is to be detected by keyword detector 32 as indicated in FIG. 4 (ST306). It is possible to set the customer service keyword which correlates to sales improvement by the learning process of such a customer service keyword.

Addition of the customer service keyword by keyword register 43 is not limited to a case where sales data as described above exceeds the threshold. For example, keyword register 43 may determine that a level of satisfaction of the customer is great based on analysis of voice that is input to voice input terminal 31 or image analyzer 22, and may perform addition of the customer service keyword in a case where the level of satisfaction of the customer is greater than the threshold. Alternatively, keyword register 43 may determine that customer service time is greater than a predetermined threshold, and may perform addition of the customer service keyword in a case where the customer service time is greater than the threshold.

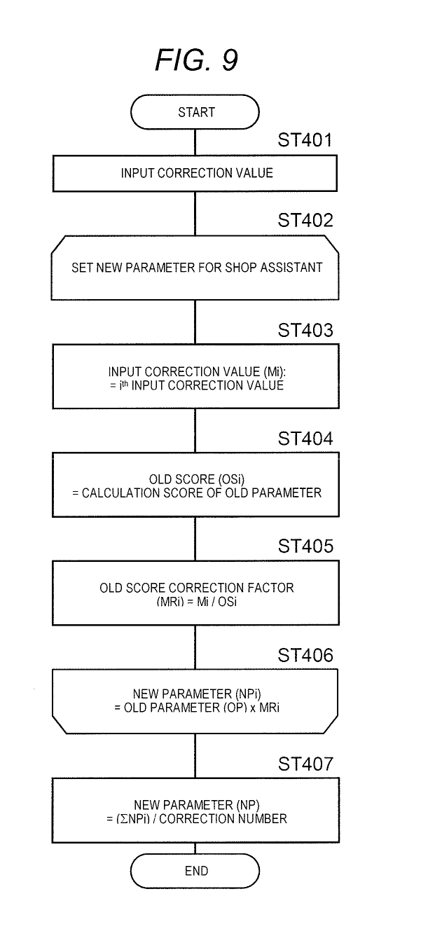

FIG. 9 is a flowchart illustrating flow of a correction process with a weighting coefficient which is used in calculation of a customer service score in customer service appraisal device 7.

As shown in FIG. 9, in the correction process of the weighting coefficient, when the user inputs the correction value of the weighting coefficient with respect to each shop assistant from operation input terminal 11 (ST401), parameter setter 37 executes calculation of a new parameter (corrected weighting coefficient) with respect to each shop assistant based on each input correction value (ST402 to ST406). In calculation of the new parameter with respect to each shop assistant, parameter setter 37 sets an i-th input correction value (correction value with respect to i-th shop assistant) as an input correction value (Mi) (ST403), and subsequently, sets the customer service score which is calculated using an old parameter (OP) (weighting coefficient prior to correction) as an old score (OSi) (ST404).

Next, parameter setter 37 calculates a correction factor (MRi) of the old score from the following equation (ST405).

correction factor (MRi) of the old score=input correction value (Mi)/old score (OSi)

Furthermore, parameter setter 37 calculates a new parameter (NPi) from the following equation (ST406).

new parameter (NPi)=old parameter (OP)×correction factor (MRi) of old score

Parameter setter 37 repeatedly executes only a number of correction values (number of shop assistants) that are input in step ST403 to ST406.

After that, parameter setter 37 calculates a value (average value of the new parameter which relates to a plurality of shop assistants) obtained by dividing a sum of the new parameter with respect to each shop assistant that is calculated in step ST406 by the number of correction values (ST407).

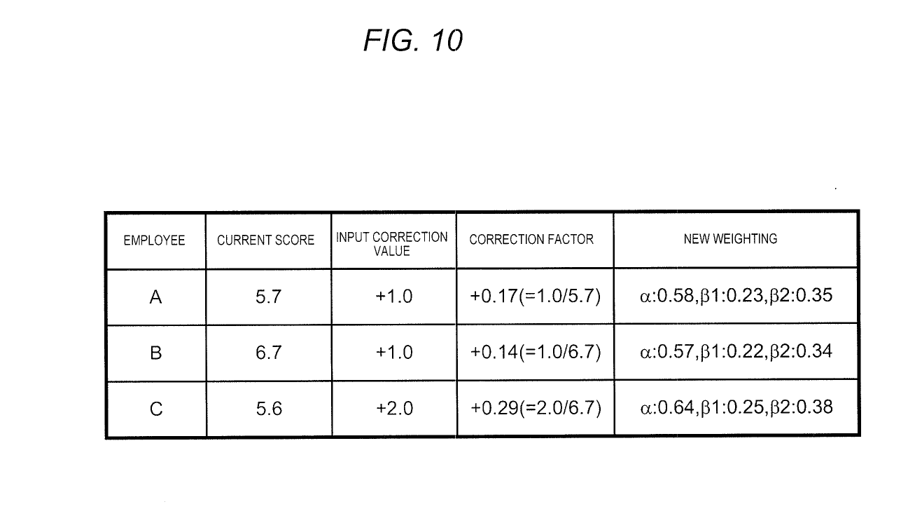

FIG. 10 is an explanatory diagram illustrating an example of a correction process with a weighting coefficient which is used in calculation of a customer service score. Here, a case is indicated where the user performs correction based on the calculation result of the customer service score indicated in FIG. 7, the weighting coefficient prior to correction (prior to update) is set as α=0.5, β1=0.2, and β2=0.3, and the input correction value (Mi) with respect to three people of employees A to C are respectively set to +1.0, +1.0, and +2.0.

The correction factor (MRi) which is calculated based on step ST405 respectively sets employees A to C to +0.17, +0.14, and +0.29. In addition, the weighting coefficient after correction which is calculated for employee A based on step ST406 is set as α=0.58, β=0.23, and β2=0.35, the weighting coefficient after correction which is calculated for employee B is set as α=0.57, β=0.22, and β2=0.34, and the weighting coefficient after correction which is calculated for employee C is set as α=0.64, β=0.25, and β2=0.38.

Finally, the correction value (average value of the new parameter) of the weighting coefficient based on step ST407 is as follows.

α(correction value)=(0.58+0.57+0.64)=0.59

β1(correction value)=(0.23+0.22+0.25)/3=0.23

β2(correction value)=(0.35+0.34+0.38)/3=0.35

The correction value (update value) of the weighting coefficient that is calculated in this manner is used in calculation of the customer service score using customer service score calculator 36.

The present embodiment is described above based on specific embodiments, but the embodiments are only examples, and the present invention is not limited by these embodiments. For example, the customer service appraisal device according to the present invention is not limited to a restaurant chain, and there is a possibility of applying to arbitrary stores where customer services are needed such as a hotel, bank, retail store, gas station, or telephone sales, a call center, and the like where customer service is carried out by only voice.

In addition, calculating the customer service score from both of the keyword score and the voice feature score is described, but the customer service score may be calculated from only the voice feature (voice feature score) of the customer service keyword.

Each configuring element of the customer service appraisal device, the customer service appraisal system, and the customer service appraisal method according to the present invention which is shown in the embodiments above is not necessarily essential, and it is possible to select, as appropriate, at least limited to not departing from the range of the present invention.

### INDUSTRIAL APPLICABILITY

A customer service appraisal device, a customer service appraisal system, and a customer service appraisal method according to the present invention are able to appropriately appraise a customer service attitude based on voice of a person during customer service, and are useful as the customer service appraisal device, the customer service appraisal system, and the customer service appraisal method which appraise the customer service attitude of the person.

### REFERENCE MARKS IN THE DRAWINGS

1 customer service appraisal system
2 store
3 camera
4 microphone
5 sensor
6 POS apparatus
7 customer service appraisal device
11 operation input terminal
12 display
15 wide area network
16 head office
17 head office PC
21 image input terminal
22 image analyzer
31 voice input terminal
32 keyword detector
33 keyword score calculator
34 voice feature acquirer
35 voice feature score calculator
36 customer service score calculator
37 parameter setter
38 score output terminal
41 auxiliary data input terminal
42 voice data temporary recorder
43 keyword register
45 data storage

1. A customer service appraisal device which appraises a customer service attitude of a person, comprising:
a voice input terminal in which voice of the person is input as a voice signal;
a keyword detector which detects one or more predetermined customer service keywords from the voice of the person by acquiring the voice signal;
a voice feature acquirer which acquires a voice feature of the customer service keyword that is detected by the keyword detector; and
an appraisal value calculator which calculates an appraisal value that is an indicator of good or bad of the customer service attitude of the person based on a comparison with the voice feature that is acquired by the voice feature acquirer and a predetermined prescribed voice feature.

2. The customer service appraisal device of claim 1, further comprising:
a voice feature difference calculator which calculates a difference value between the voice feature that is acquired by the voice feature acquirer and the predetermined prescribed voice feature,
wherein the appraisal value calculator calculates the appraisal value based on the difference value.

3. The customer service appraisal device of claim 2,
wherein the prescribed voice feature is a voice feature that is predetermined for each customer service keyword and preferred as the customer service keyword, and in the calculation of the appraisal value, the smaller the difference, the better the customer service attitude of the person is appraised.

4. The customer service appraisal device of claim 2,
wherein the prescribed voice feature is a voice feature that is predetermined for each customer service keyword and standard as the customer service keyword, and in the calculation of the appraisal value, in a case where the difference value is large in a positive direction, the customer service attitude of the person is appraised to be good, and in a case where the difference value is large in a negative direction, the customer service attitude of the person is appraised to be bad.

5. The customer service appraisal device of claim 1,
wherein the customer service keywords are grouped for each application, and the prescribed voice feature of the customer service keywords belonging to the same group is provided with a common predetermined voice feature.

6. The customer service appraisal device of claim 1,
wherein the prescribed voice feature is provided with a predetermined voice feature with respect to a specific word in a case where the specific word which is a predetermined word is included in a portion of the customer service keywords.

7. The customer service appraisal device of claim 1,
wherein the prescribed voice feature is predetermined as male voice or female voice in each customer service keyword, use of the prescribed voice feature according to the male voice and use of the prescribed voice feature according to the female voice are switched according to the voice of the person, and the difference value is calculated.

8. The customer service appraisal device of claim 1,
wherein the appraisal value calculator calculates the appraisal value based on the sum of the difference value that is weighted in each type of the voice feature.

9. The customer service appraisal device of claim 8, further comprising:
a voice feature weighting decider which dynamically changes a weighting coefficient of the weighting for each type of the voice feature based on a learning function.

10. The customer service appraisal device of claim 1,
wherein the voice feature includes at least one of tone of voice, speed of voice, volume of voice, emotion, and smiling voice.

11. The customer service appraisal device of claim 1,
wherein the appraisal value calculator reflects a detection amount of the customer service keyword that is detected by the keyword detector in the appraisal value.

12. The customer service appraisal device of claim 11,
wherein the detection amount of the customer service keyword is a detection number of the customer service keyword that is detected per predetermined unit time or unit event.

13. The customer service appraisal device of claim 12,
wherein the appraisal value calculator reflects the sum of the detection number of the customer service keyword that is weighted in each type of customer service keyword in the appraisal value.

14. The customer service appraisal device of claim 13, further comprising:
a keyword weighting decider which dynamically changes a weighting coefficient of the weighting for each type of the customer service keyword based on a learning function.

15. The customer service appraisal device of claim 1,
wherein the keyword detector detects the customer service keyword in a predetermined period of time with a time of a customer visit as a reference.

16. The customer service appraisal device of claim 1 further comprising:
a data input terminal in which sales data according to customer service of the person is input; and
a display which displays correlation between the sales data and the appraisal value.

17. A customer service appraisal system including a customer service appraisal device which appraises a customer service attitude of a person, and a management apparatus which is connected to be able to communicate with the customer service appraisal device via a network and which receives information including at least an appraisal value from the customer service appraisal device,
wherein the customer service appraisal device includes
a voice input terminal in which voice of the person is input as a voice signal;
a keyword detector which detects one or more predetermined customer service keywords from the voice of the person by acquiring the voice signal;
a voice feature acquirer which acquires a voice feature of the customer service keyword that is detected by the keyword detector; and
an appraisal value calculator which calculates an appraisal value that is an indicator of good or bad of the customer service attitude of the person based on a comparison with the voice feature that is acquired by the voice feature acquirer and a predetermined prescribed voice feature.

18. A customer service appraisal method which appraises a customer service attitude of a person, comprising:
inputting voice of the person as a voice signal;
detecting one or more predetermined customer service keywords from the voice of the person by acquiring the voice signal;
acquiring a voice feature of the detected customer service keyword; and
calculating an appraisal value that is an indicator of good or bad of the customer service attitude of the person based on a comparison with the acquired voice feature and a predetermined prescribed voice feature.

19. The customer service appraisal method of claim 18, further comprising:
calculating a difference value between the acquired voice feature and the predetermined prescribed voice feature; and
calculating the appraisal value based on the difference value.

20. The customer service appraisal method of claim 18, further comprising:
detecting the customer service keyword in a predetermined period of time with a time of a customer visit as a reference from the voice of the person.
